(19) United States
(12) Patent Application Publication
(10) Pub. No.: US 2003/0179654 A1
(43) Pub. Date: Sep. 25, 2003

(54) Wellness alarm watch

(76) Inventor: Deborah Latzke, Minneapolis, MN (US)

Correspondence Address: Mark A. Litman & Associates, P.A., York Business Center, Suite 205, 3209 West 76th St., Edina, MN, 55435, US

(21) Appl. No.: 10/106,425

(22) Filed: Mar. 20, 2002

(51) Int. Cl. G04B 47/00; G04C 21/00; G04C 23/00; G04B 23/02

(52) U.S. Cl. 368/73; 368/82

(57) ABSTRACT

A watch comprises a display means for displaying time and panel, face plate, backlit alphanumerics, or other display that provides a specific indication that a wellness act is to be performed. The watch has an alarm function that is programmable/adjustable by the wearer so that specific times during the day or specific intervals during the day can be indicated as the time for the performance of a specific or generic wellness act. This type of alert function can take many different forms. The time function of the watch, indicating the specific time of the day, may be minimal to the function of the watch (e.g., may take up a major portion of the surface area of the watch face).

### BACKGROUND OF THE INVENTION

1. Field of the Invention

The present invention relates to watches, more specifically to a character panel for watches having the capability to display information besides the time, such as a command to engage in a wellness act.

2. Background Art

From various traditional medical teachings, it is known that humans have a need to relax, interact with other human beings, and perform acts that contribute to their well-being. For example, there have been studies indicating that visits by children or pets in nursing homes and emotional support facilities increase the well-being of residents. These actions have no definitive time reliance, as due life cycle events or life rhythm events which depend upon the time of day. Because the time of day and specific times of day are not associated with a need to engage in acts to enhance wellness, it is difficult to structure a day or indicate a time to an individual to engage in activities that are specifically beneficial to their health, yet general in nature.

U.S. Pat. No. 5,638,341 describes a watch with panels thereon that divide the day into segments of life cycles that are believed to be consistent with times and specific time periods during the day. For example, it is first stated that the time periods from 6 a.m.-10 a.m. and 6 p.m.-10 p.m. are the best times for thinking, and are called Kapha (K) referring to the quality of stability/peacefulness in the body. When exercising during these time periods it is best to exercise lightly, and everyday labor should be performed only lightly as well. In addition, it is not advisable to eat or drink during these time periods. Kapha (K) is symbolized by “green”. Second, its is asserted that the time periods from 10 a.m.-2 p.m. and 10 p.m.-2 a.m. are the time periods for digestion and change, and are called Pitta (P) referring to the quality of activity. That is, the daytime period is an appropriate time period for eating, and is suited to digestive/metabolic activity. During the nighttime period, the matter absorbed through digestion is converted into flesh, particularly that of the extremities. Pitta (P) is symbolized by “red”. Third it is asserted that the time periods from 2 a.m.-6 a.m. and 2 p.m.-6 p.m. are the time periods for activity and exercise, and are called Vata (V) referring to the quality of freshness/lightness. That is, the daytime Vata (V) is suitable for moving the body including comparatively heavy exercise. Additionally, regarding the early morning Vata (V), such phenomena as the bringing about of a good awakening due to the quality of freshness/lightness are able to be seen. Furthermore, as states of slumber, there are REM sleep and non-REM sleep. REM sleep is a state of slumber which is accompanied by bodily activity such as movement of the eyeballs, and the fact that REM sleep becomes longer during the Vata (V) from 2 to 3 o'clock has been made clinically clear. The daily bodily quality, activity quality, and seasonal quality are described by the three qualities of the Vata (V), the Pitta (P), and the Kapha (K). Slumber is taken in the time period from 10 p.m. to 6 a.m., and in the time periods of the Pitta (P) and the Vata (V) the decay of the dosha which is the bodily balance is undone. For example, the changing of one's position during sleep may be seen as such a phenomenon. The above division of time is given the name “Ayurveda time”. The above example is for the case in which sunrise occurs at 6 a.m. and sundown occurs at 6 p.m., but generally, the Kapha (K), Pitta (P), and Vata (V) are determined by respectively splitting into three equal parts the time periods from sunrise to sundown and from sundown to sunrise. Furthermore, the “time” referred to here is not the standard time, but rather the time for the case in which noon is taken as the time at which the sun lies directly south of the region in which the relevant person is living. Thus, Ayurveda time changes with respect to the location, the season, and day and night. These different time periods are identified by a face plate with a painted panel that is changeable only by rotation of the panel to shift different colored segments under the hands of a watch. The length of these periods cannot be altered.

The awareness that mental health and physical health are inseparable has been known for many of years. John Locke observed that “A sound mind in a sound body, is a short but full description of a happy state in this world. He that has these two, has little more to wish for; and he that wants either of them, will be little the better for anything else.” Many different programs, religious or spiritual practices and exercises and routines have been developed over the years to assist in an individual actively maintaining spiritual or emotional balance. Among these practices have been EST, Transcendental Meditation, Yoga, mantra repetition, wellness moments, time outs, Random Acts of Kindness, and the like. Much research has supported anecdotal evidence or folk belief that mental health or heightened spirits assists the body in fighting disease and in sustaining good physical health.

It is difficult enough in the press of time in the modern age to remember to accurately take drug medication and drug therapy, and the failure to properly complete drug maintenance on a prescribed schedule is well understood to be a very serious health problem, particularly for the elderly and those with diseases that require a strict drug regimen, for whom the taking of multiple medications is common. Often the appropriate efficacy levels of the medication are not reached or maintained, resulting in deterioration of health status and increased need of preventable hospital days and medical procedures. Noncompliance, defined in medical parlance as the failure to follow through with therapy as prescribed by one's physician, is recognized as a major impediment to improved health. More than 80% of the 36.3 million people over 65 are on an active medication regimen, typically taking multiple medications daily. It is estimated that approximately fifty percent (50%) of patients with illness do not comply with their medication regimen, with the elderly making up a significant portion of this population. Failure to comply with one's medication regimen is associated with deterioration of health status, resulting in an escalation of medical costs for individuals and insurers, as well as an increase in preventable fatalities.

A significant portion of compliance problems result from patients' difficulty in remembering to properly follow complicated treatment (i.e. multiple medications). Forgetfulness to self-administer the prescribed medications at the correct daily intervals and correct dosages by patients has long been found to be a major impediment for doctors in determining the effectiveness of prescriptions. It is also well know that the more frequently a medication must be taken, the less likely the patient's compliance. Pharmaceutical companies consequently spend tremendous sums of money and time developing medications that need be taken only once daily, but many medications are simply not amenable to once-daily dosing regimes. For the patient who must take three, four, or even five dosages of several medications daily, the prescribed regimens can easily become confusing. Many patients carry written timetables with them during the day. Pills are often set up in adjustable packets that can “line up” the medications to be taken. This can be effective, but does not solve the possibility of the patient becoming distracted or simply forgetful.

For drug performed medication, some electronic reminder systems do exist, such as that described in U.S. Pat. No. 5,157,640 to Backner (1992). The Backner system utilizes a programmable electronic watch that generates different tones to indicate the number of types of medications to be taken and identifies the medication and dosage in a limited display on the face of the watch. The watch is programmed via connecting pins in a cradle linked to the programming computer. One problem with this approach is that the connecting pins frequently become dirty or damaged, causing the transfer to fail. Metal pins can also cause susceptibility of the system to Electro-Static Discharge (ESD). The Backner system also only allows limited identification information to be transferred from the watch to the host computer and thus does not provide for full two-way information transfer both to and from the watch in order to allow downloading of compliance and patient medical event information to the host computer for review by the physician, pharmacist, or other health care provider.

It is an even more difficult problem for individuals to remember to modify their behavior as part of a medical regimen or self-help practice. The tendency of individuals to maintain routines in their lives and the difficulty in breaking routines or scheduling habits hinders many good mental health practices.

Various monitors are known in the art, specifically those that measure physiological conditions and/or alert patients of the need for medication events. However, these monitors fail to fully meet the needs addressed above. In most instances these monitors require the user of the monitor to activate the monitor to transmit a warning signal and/or require distal monitoring of transmitted signals to alert patients. None of these monitors have to date provided alerts or indications for self-help, non-medicated or non-diagnostic mental health events.

As such, a need exists for a personal wellness event alerting system that allows an individual to provide messages or timely reminders that time should be taken and activities initiated that should assist in maintaining mental wellness and life balance. The present invention provides such a system.

### SUMMARY OF THE INVENTION

The present invention takes account of the above circumstances, and has as an aspect of the invention the presentation of a watch and a character panel that can exhibit a command to perform a wellness function or specifically indicate that it is time to perform a wellness act.

A watch according to the present invention comprises a display means for displaying time and panel, face plate, backlit alphanumerics, or other display that provides a specific indication that a wellness act is to be performed. The watch has an alarm function that is programmable/adjustable by the wearer so that specific times during the day or specific intervals during the day can be indicated as the time for the performance of a specific or generic wellness act. This type of alert function can take many different forms. The time function of the watch, indicating the specific time of the day, may be minimal to the function of the watch (e.g., may take up a minor portion of the surface area of the watch face).

### BRIEF DESCRIPTION OF THE FIGURES

FIG. 1 is a frontal view of a Wellness Alarm Watch of the present invention.

### DETAILED DESCRIPTION OF THE INVENTION

According to the present invention, the display means preferably includes a) a time display function such as watch hands for displaying the time, a digital display, a liquid crystal display, or other non-rotating hand display for indicating time, b) an alarm function that can be programmed to provide an alarm to the wearer at specific times during the day or at specific intervals during the day; and c) a visual indication that a wellness event should be undertaken or should occur.

Wellness events can cover a range of non-specific, non-medicinal events. Excluded from consideration of wellness events is an alert to take medication or undergo a prescribed medical treatment or therapy. By wellness event, for example, are personal interactive activities and self-administered actions designed to enhance feelings of self-worth, mental health and/or wellness. For example, wellness events might include 1) giving a complement to another person or to oneself, 2) giving a hug to a person or pet, 3) taking a music relaxation break, 4) making a list of positive conditions in one's life, 5) calling a friend or relative, 6) affirmation of a goal, particularly a daily goal, 7) take a specific action to effect a life change (e.g., add to a resume′ or mail a resume), 8) celebrate passage of an abstention goal (celebrate sobriety or other abstinence), 9) say a prayer, 10) express gratitude for a specific event or state in one's life, 11) make a list of friends, 12) take a relaxation, mental health break, deep-breathing exercise, meditation break, or other active relaxation step, or other event that requires less then five minutes and preferably less than two minutes of time to perform, yet contributes to the wellness of the watch user without requirement for actual medical treatment. The wellness alerts are intended to remind the wearer that life enhancing actions are performed in the present moment—NOW—not in the past or distant future. The present time is when we access the power to change, think, speak or act in a way that crates a positive change in our wellness and the lives of others around us.

Additionally, the watch according to the present invention is provided with a character panel having a plurality of available displays or an alterable display region. By an alterable display is a conventional, programmable liquid crystal display where specific and short (less than forty characters, preferably less than twenty characters) messages or signals can be provided and programmed into the display area. For example, the display can be programmed to state “Hug Someone. NOW!” or “NOW!” or “Call a Friend” or Listen to Bach” or “Listen to Rock” or “Make a Good List” or “Add to Your Good List” or the like. Additionally, readily replaceable faceplates that can provide specific, preprinted displays with wellness messages. A stock of these faceplates can be stored in a back panel on the watch. For example, where the back of the watch is opened to store the battery, a stacked array of faceplate panels or even just one additional panel may be provided.

The display, as indicated above, may be any visual display. The alarm function in the watch may be any programmable or adjustable alarm system, including audio alarms, vibration alarms, video alarms or combinations of the three. These are standard alarm functions known in the art and may be added to the wellness display system of the invention.

The time display is actually optional, although most users would appreciate the combination of the wellness alert function and traditional time display. Time display may be with moveable hands (less preferred) or a panel display of time (e.g., liquid crystal display, rotating reels displaying time, led display, etc.). These are preferred because they can be designed to use less energy (making the life of the battery greater) and can be designed to take up a lesser portion of the display area on the face of the watch. For example, the time display may take up less than 50% of the total display area on the face of the watch, take up less than 40%, take up less than 30%, take up less than 20%, and take up less than 10% of the total display area (surface area) on the watch face.

Other objects and attainments together with a fuller understanding of the invention will become apparent and appreciated by referring to the following description and claims taken in conjunction with the accompanying drawings.

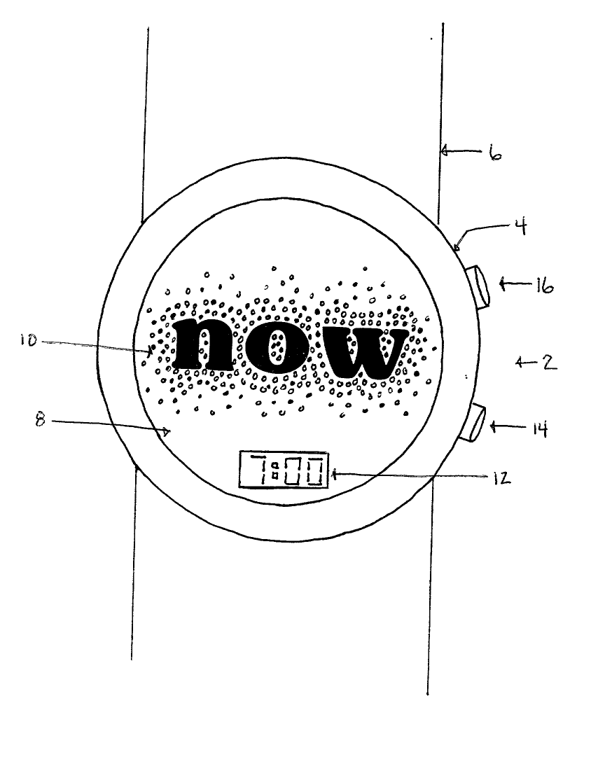

FIG. 1 is a frontal view of a Wellness Alarm Watch 2 of the present invention. The watch 2 comprises a frame 4, a watchband 6, and a faceplate 8. The faceplate has a wellness display 10 showing an alert notice of “now” on a colored background. A time display 12 in the form of a small liquid crystal display panel is provided. Wearer programming stems 14 and 16 are provided. For example, those two stems 14 and 16 may be used to program the time on panel 12, or, where the wellness display 10 is in the form of another programmable panel (not shown, but merely in the place of the words printed on the faceplate 8), used to add or modify the wellness display. The two stems 14 and 16 may be used to program the time interval or the specific time(s) of day when the wellness alert is provided. Specific programming functions within the microprocessor may be preprogrammed or provided from a list of times that may be selected by the user.

These examples should be considered as non-limiting except where a specific intent to limit the scope of the invention has been made.

What is claimed:

1. A watch to provide a message to a wearer of a time to engage in a wellness act comprising a timing element, a faceplate providing a display area, a programmable alarm system controlled by the timing element, and a display area that displays a message specific to performance of an act of wellness.

2. The watch of claim 1 wherein the specific message is an indication in alphanumerics indicating that an wellness act should be performed now.

3. The watch of claim 1 wherein the specific message is selected from the group consisting of 1) giving a complement to another person or to oneself, 2) giving a hug to a person or pet, 3) taking a music relaxation break, 4) making a list of positive conditions in one's life, 5) calling a friend or relative, 6) affirmation of a goal, 7) taking a specific action to effect a life change, 8) celebrate passage of an abstention goal, 9) say a prayer, 10) express gratitude for a specific event or state in one's life, 11) make a list of friends, and 12) take a relaxation break from work.

4. The watch of claim 1 wherein the display area comprises a programmable display area.

5. The watch of claim 4 wherein the specific message is selected from the group consisting of 1) giving a complement to another person or to oneself, 2) giving a hug to a person or pet, 3) taking a music relaxation break, 4) making a list of positive conditions in one's life, 5) calling a friend or relative, 6) affirmation of a goal, 7) taking a specific action to effect a life change, 8) celebrate passage of an abstention goal, 9) say a prayer, 10) express gratitude for a specific event or state in one's life, 11) make a list of friends, and 12) take a relaxation break from work.

6. The watch of claim 5 wherein at least two messages selected from 1) through 12) are preprogrammed into a memory in the watch.

7. The watch of claim 1 wherein a time display area is present on the faceplate.

8. The watch of claim 1 wherein no time display area is present on the faceplate.

9. The watch of claim 7 wherein the time display area comprises less than 40% of the total surface area of the faceplate.

10. The watch of claim 7 wherein the time display area comprises less than 30% of the total surface area of the faceplate.

11. The watch of claim 7 wherein the time display area comprises less than 20% of the total surface area of the faceplate.

12. The watch of claim 7 wherein the specific message is selected from the group consisting of 1) giving a complement to another person or to oneself, 2) giving a hug to a person or pet, 3) taking a music relaxation break, 4) making a list of positive conditions in one's life, 5) calling a friend or relative, 6) affirmation of a goal, 7) taking a specific action to effect a life change, 8) celebrate passage of an abstention goal, 9) say a prayer, 10) express gratitude for a specific event or state in one's life, 11) make a list of friends, and 12) take a relaxation break from work.

13. The watch of claim 9 wherein the specific message is selected from the group consisting of 1) giving a complement to another person or to oneself, 2) giving a hug to a person or pet, 3) taking a music relaxation break, 4) making a list of positive conditions in one's life, 5) calling a friend or relative, 6) affirmation of a goal, 7) taking a specific action to effect a life change, 8) celebrate passage of an abstention goal, 9) say a prayer, 10) express gratitude for a specific event or state in one's life, 11) make a list of friends, and 12) take a relaxation break from work.
